(19) United States
(12) Patent Application Publication
(10) Pub. No.: US 2019/0317245 A1
(43) Pub. Date: Oct. 17, 2019

(54) TRANSFER FILM HAVING PHOTONIC CRYSTAL STRUCTURE AND MANUFACTURING METHOD THEREOF

(71) Applicants: Suzhou University of Science and Technology, Suzhou (CN); Suzhou Nanoforever Materials Technology Co., Ltd., Suzhou (CN)

(72) Inventors: Changqing YE, Suzhou (CN); Shirong ZHENG, Suzhou (CN); Qiang WEN, Suzhou (CN); Renmei DOU, Suzhou (CN); Houguang XU, Suzhou (CN); Yanlin SONG, Suzhou (CN)

(21) Appl. No.: 16/450,015

(22) Filed: Jun. 24, 2019

Related U.S. Application Data
(63) Continuation of application No. PCT/CN2016/113077, filed on Dec. 29, 2016.

(51) Int. Cl. G02B 1/00; B29D 11/00

(52) U.S. Cl. CPC G02B 1/005; B29D 11/00788

(57) ABSTRACT

The present invention discloses a transfer film having a photonic crystal structure and a manufacturing method thereof. The transfer film having photonic crystal structure is obtained by forming a photonic crystal layer on an assembly substrate, and transferring the photonic crystal layer on the assembly substrate onto the printing substrate. The present invention also provides a method for manufacturing the above transfer film.

### CROSS-REFERENCE TO RELATED APPLICATION

This application is a continuation application of International patent application No. PCT/CN2016/113077, filed on Dec. 29, 2016, which is incorporated herein by reference in its entirety and for all purposes.

### FIELD OF THE INVENTION

The present invention relates to a transfer film, and more particularly to a transfer film having a photonic crystal structure and a manufacturing method thereof.

### BACKGROUND OF THE INVENTION

Photonic crystal is a novel optical material with different dielectric constants and periodic spatial distribution. Due to its special photoregulation properties, photonic crystal has a wide application prospect in the fields of optics, electronics, chemistry and biochemistry. The principle of color formation in photonic crystals is that light is modulated by Bragg diffraction of the periodic structure, and the corresponding structural color can be obtained by reflecting the forbidden light of the photonic crystal itself. This color development process is simple, stable, inexpensive, environmentally friendly and pollution-free, and has the advantages of color change with viewing angle, wide regulation range, convenient regulation and long-lasting color. It is a powerful substitute for traditional chemical pigments and dyes, and its special spectral characteristics, such as high saturation, color change with angle, intelligent response and the like, make it have broad application prospects in the fields such as intelligent packaging and anti-counterfeiting.

A number of methods have been disclosed for manufacturing photonic crystals so far, one of which is a colloidal self-assembly method. Briefly, the colloidal self-assembly method is: dispersing photo-crystal colloidal particles in a solvent continuous phase to form a colloidal dispersion system, and then coating the colloidal dispersion system to a assembly substrate by an appropriate technical means, and removing the continuous phase in the colloidal dispersion under suitable external conditions, such as temperature control, humidity control, low pressure, and the like. In this process, the dispersion phase in the colloidal dispersion system self-assembles to form a regular and ordered arrangement pattern, thereby generating an optical structure with periodic distribution and different dielectric constants, resulting in a structural color. The photonic crystal prepared by the colloid self-assembly method has a structure similar to that of the natural opal, which is also called an opal-type photonic crystal.

In the prior art, the self-assembly of the photonic crystal material is directly performed on a printing substrate. In order to obtain better photonic crystal assembly quality, it is often necessary to control external conditions such as temperature and humidity. Moreover, the assembly process is slow and time consuming, and further has very high requirements for the printing substrate. In order to obtain an acceptable assembly effect, the roughness, wettability, and water and solvent resistance of a surface of the printing substrate need to be matched with the assembly conditions of the colloidal photonic crystal emulsion. For some assembly schemes for patterning, it is even necessary to perform wettability regulation on the printing substrate for patterning. These all severely limit the selection of the printing substrate, greatly increase process difficulty, and thus increase the cost.

Moreover, in some schemes, in order to obtain the physical properties of photonic crystals suitable for the printing substrate, such as adhesion, luster, leveling and film-forming properties and other parameters, corresponding additives should be added. However, the self-assembly process of photonic crystals is realized by the weak interaction of intermolecular forces, and the addition of the additives to the system will indirectly affect the assembly quality of photonic crystals, or even make them unable to be assembled. These factors affect the promotion of the application of photonic crystal products.

Therefore, the colloid self-assembly method in the prior art still has the following problems to be overcome. The self-assembly of colloidal microspheres has a slow rate due to the high requirements on the assembly environment (such as constant temperature, constant pressure, constant humidity, etc.). Moreover, the assembly substrate has a poor selectivity, and usually cannot be assembled on a surface of a porous substrate (such as fiber paper) or a curved substrate (such as a package bottle) to form a structural color, and can be applied to the manufacturing methods such as a gravity deposition method, a vertical deposition method, a pulling method, a spin coating method, etc. only when assembled on a surface of some smooth and rigid substrates. Furthermore, the photonic crystal layer formed after the assembly of the colloidal microspheres has poor adhesion to the substrate and is easily peeled off, has poor structural strength and is not scratch resistant. In addition, the assembly effect of the colloidal microspheres is sensitive to the composition of the emulsion, making it difficult to add additional additives in the emulsion, and the viscosity and leveling property of the emulsion itself are difficult to adjust, making the emulsion less suitable for printing coating, resulting in difficulty in balance of the assembly effect and printing quality. In the process of patterning, it is difficult to obtain a high-quality direct assembly pattern due to the difficulty in balance of the printing suitability of the emulsion itself and assembly effect, and, due to the existence of coffee ring effect, the assembly quality at the edge of the photonic crystal pattern is affected, and the assembly form may have significant color difference with the central part of the pattern.

### SUMMARY OF THE INVENTION

In view of the deficiencies of the prior art, the technical problem to be solved by the present invention is how to provide a photonic crystal layer on a flexible substrate.

In order to achieve the above object, an aspect of the present invention provides a transfer film having a photonic crystal structure, comprising: an assembly substrate, a photonic crystal layer, a transfer layer, and a printing substrate.

Further, the photonic crystal layer comprises a nanosphere layer formed by periodic arrangement of nanospheres, and the nanosphere layer has a close-packed structure, which gives the optical functional material a luster.

Further, the raw material of the nanosphere is selected from the group consisting of polystyrene, polyacrylate, polyacrylic acid, silica, alumina, titania, zirconia, polyimide, silicon resin, iron oxide (e.g., ferroferric oxide) and phenolic resin ester.

Further, the luster of the photonic crystal layer is infrared light, visible light or ultraviolet light having a wavelength of 200 to 2000 nm.

Further, the nanospheres are filled with a filling medium whose dielectric constant is different from that of the nanospheres.

Further, the nanosphere has a PDI of less than 0.05.

Preferably, the assembly substrate is a polyethylene terephthalate (PET) film, a polypropylene (PP) film, a polyethylene (PE) film, a cellulose film, a polyvinyl alcohol (PVA) film, a PVC film or paper.

More preferably, the printing substrate is a porous substrate, a curved substrate or a low-surface energy material substrate, wherein the porous substrate includes fiber paper, cloth, leather, wood or a substrate material having a rough and porous surface and capable of absorbing a photonic crystal emulsion, and the curved substrate includes a curved paper, plastic, glass, ceramic, leather, wood, metal or substrate material on a surface of which a photonic crystal emulsion cannot be spread, assembled and cured to form the photonic crystal layer.

Further, the transfer layer is made of a hot melt adhesive or a UV resin precursor.

In a preferred embodiment, the transfer film provided by the present invention further comprises a release layer, which is between the assembly substrate and the photonic crystal layer.

Further, the release layer has a surface tension coefficient of 42 dyn/cm to 58 dyn/cm, and the photonic crystal layer has a thickness of 2 μm to 20 μm.

In another aspect, the present invention provides a manufacturing method of a transfer film having a photonic crystal structure, including the following steps: providing an assembly substrate; preparing a photonic crystal emulsion; coating the prepared photonic crystal emulsion on a surface of the assembly substrate, curing the photonic crystal emulsion on the surface of the assembly substrate into a photonic crystal layer; bonding the photonic crystal layer to a printing substrate by transfer and forming a transfer layer, and then optionally removing the assembly substrate.

Further, the step of coating the photonic crystal emulsion on the surface of the assembly substrate comprises: coating the photonic crystal emulsion on the surface of the assembly substrate (e.g., by a roll-to-roll coating process) to obtain a continuous photonic crystal layer.

Further, the step of bonding the photonic crystal layer to the printing substrate by transfer and forming the transfer layer comprises: coating a hot melt adhesive solvent on a surface of the photonic crystal layer or a surface of the printing substrate, followed by drying, and then stamping a three-dimensional structural surface of a thermoprint mold on the printing substrate or the assembly substrate to form an apparently three-dimensional pattern surface, thereby bonding the photonic crystal layer to the printing substrate and forming the transfer layer.

Further, the step of bonding the photonic crystal layer to the printing substrate by transfer and forming the transfer layer comprises: coating a UV resin precursor on the surface of the photonic crystal layer or the surface of the printing substrate, followed by ultraviolet light irradiation, and then stamping a three-dimensional structural surface of an imprint mold on the printing substrate or the assembly substrate, and then completely curing the resin film to form an apparently three-dimensional pattern surface, thereby bonding the photonic crystal layer to the printing substrate and forming the transfer layer.

Further, the step of bonding the photonic crystal layer to the printing substrate by transfer and forming the transfer layer comprises: printing a UV resin precursor on the surface of the photonic crystal layer or the surface of the printing substrate, followed by ultraviolet light irradiation to form a three-dimensional pattern surface, and then completely curing the resin film to form an apparently three-dimensional pattern surface, thereby bonding the photonic crystal layer to the printing substrate and forming the transfer layer.

In another aspect, the present invention also provides a manufacturing method of a transfer film having a photonic crystal structure, including the following steps: providing an assembly substrate; forming a release layer on a surface of the assembly substrate, the release layer for regulating an interface property of the assembly substrate; preparing a photonic crystal emulsion; coating the prepared photonic crystal emulsion on a surface of the release layer, curing the photonic crystal emulsion on the surface of the release layer into a photonic crystal layer; bonding the photonic crystal layer to a printing substrate by transfer and forming a transfer layer, and then optionally removing the assembly substrate.

Further, the step of coating the photonic crystal emulsion on the surface of the assembly substrate comprises: coating the photonic crystal emulsion on the surface of the assembly substrate (e.g., by a roll-to-roll coating process) to obtain a continuous photonic crystal layer.

Further, a bonding force between the release layer and the photonic crystal layer is greater than that between the assembly substrate and the release layer.

Further, the step of bonding the photonic crystal layer to the printing substrate by transfer and forming the transfer layer comprises: coating a hot melt adhesive solvent on a surface of the photonic crystal layer or a surface of the printing substrate, followed by drying, and then stamping a three-dimensional structural surface of a thermoprint mold on the printing substrate or the assembly substrate to form an apparently three-dimensional pattern surface, thereby bonding the photonic crystal layer to the printing substrate and forming the transfer layer.

Further, the step of bonding the photonic crystal layer to the printing substrate by transfer and forming the transfer layer comprises: coating a UV resin precursor on the surface of the photonic crystal layer or the surface of the printing substrate, followed by ultraviolet light irradiation, and then stamping a three-dimensional structural surface of an imprint mold on the printing substrate or the assembly substrate, and then completely curing the resin film to form an apparently three-dimensional pattern surface, thereby bonding the photonic crystal layer to the printing substrate and forming the transfer layer.

Further, the step of bonding the photonic crystal layer to the printing substrate by transfer and forming the transfer layer comprises: printing a UV resin precursor on the surface of the photonic crystal layer or the surface of the printing substrate, followed by ultraviolet light irradiation to form a three-dimensional pattern surface, and then completely curing the resin film to form an apparently three-dimensional pattern surface, thereby bonding the photonic crystal layer to the printing substrate and forming the transfer layer.

In the present invention, the release layer on the film may be used as a prime coat for the photonic crystal emulsion, and the interfacial properties of the surface of the release layer is controlled, or the photonic crystal emulsion is prepared according to a surface tension coefficient of the assembly substrate, so that the photonic crystal emulsion may be uniformly coated on the surface of the release layer or directly coated on the surface of the assembly substrate to achieve a large-area and defect-free coating effect and increase coating speed, thereby reducing coating time and cost. After the photonic crystal emulsion forms a photonic crystal layer on the surface of the release layer (prime coat) or the surface of the assembly substrate, the adhesive transfer layer may be formed on the surface of the photonic crystal layer, and the surface of the transfer layer may be formed with an apparently three-dimensional pattern surface by hot stamping or ultraviolet cross-linking. Meanwhile, through the adhesive transfer layer, the photonic crystal layer has good adhesion with the printing substrate, and the apparently three-dimensional pattern surface on the cured transfer layer has good abrasion resistance and scratch resistance, and further the transfer film having the photonic crystal structure is obtained.

### DETAILED DESCRIPTION OF THE INVENTION

The main component of the silicone release agent selected in the present invention comprises one or a mixture of more of a silicone resin, a wax and a matting powder. The composition of the silicone release agent may be adjusted to control the release agent effectively spreading and adhering on the surface of the assembly substrate to form a continuous and smooth release layer, and to control the interfacial properties of the surface of the release layer, which ensures that the photonic crystal emulsion may be stably spread into a film on the surface of the release layer and maintain a low bonding force with the release layer after the photonic crystal emulsion is cured into a photonic crystal layer, and ensures complete separation of the photonic crystal layer from the release layer without residue after transfer.

The main component of the resin release agent selected in the present invention comprises one or a mixture of more of a polyurethane resin, an acrylic resin, a matting powder and a cellulose material. The composition of the resin release agent may be adjusted to control the film forming property and adhesion of the release layer on the assembly substrate, which ensures that the release layer may be effectively separated from the assembly substrate after transfer, with clear cut edges and no residue, while ensuring that the photonic crystal emulsion may be stably spread into a film on the release layer and maintain a low bonding force with the release layer after the photonic crystal emulsion is cured into a photonic crystal layer, and ensuring the toughness and hardness of the release layer after film formation, and ensuring that the release layer may be firmly covered on the surface of the transferred photonic crystal layer to function as a protective layer.

### Embodiment 1

A manufacturing method of a transfer film having a photonic crystal structure disclosed in one embodiment of the present invention includes the following steps:

Step 110: providing an assembly substrate; Step 120: forming a release layer on a surface of the assembly substrate, the release layer for adjusting the interfacial properties of the assembly substrate;

Step 130: preparing a photonic crystal emulsion according to a surface tension coefficient of the release layer; and

Step 140: coating the photonic crystal emulsion on a surface of the release layer, and curing the photonic crystal emulsion on the surface of the release layer into a photonic crystal layer.

### Example 1

Step 110: providing an assembly substrate.

The assembly substrate may be a flexible and rollable substrate for use in a roll-to-roll coating process. The assembly substrate may be, but not limited to, a polyethylene terephthalate (PET) film, a biaxially oriented polypropylene (BOPP) film, a polyethylene (PE) film, a cellulose film, a polyvinyl alchohol (PVA) film or paper. In this example, the assembly substrate was polyethylene terephthalate (PET) film, but not limited thereto.

Step 120: A silicone release agent was directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 28 dyn/cm to 35 dyn/cm (dyne per centimeter), but not limited thereto.

Step 130: preparing a polystyrene microsphere suspension emulsion.

Firstly, 0.58 g of sodium dodecyl sulfate (SDS) was dissolved in 90 mL of deionized water (DI water), and nitrogen gas was introduced while bubbling under uniformly stirring at 300 r/min for about 30 minutes. Subsequently, the temperature was raised to 85° C. by heating in a water bath. After the temperature was stable, 5 g of styrene (St) monomer was further added. After nitrogen gas was introduced while bubbling under uniformly stirring at 300 r/min for about 15 minutes, 0.10 g of potassium persulfate was added, and the mixture was reacted for 5 hours under stirring, under nitrogen atmosphere and at 85° C. to obtain a polystyrene microsphere suspension emulsion having a solid content of 5%, that is, a photonic crystal emulsion, in which the polystyrene microspheres had a particle diameter of 215 nm and a polydispersivity index (PDI) of 0.02.

It should be noted that the above example of preparing the photonic crystal emulsion is only for illustrating the present invention and do not limit the scope of the present invention, and the implementation conditions employed may be further adjusted according to specific operating conditions, and the unspecified implementation conditions are usually those in the conventional experiment.

Step 140: coating the photonic crystal emulsion on a surface of the release layer.

The photonic crystal emulsion was coated on the surface of the release layer by a roll-to-roll coating process. When the photonic crystal emulsion completely and uniformly covered the release layer, it was dried at 75° C. The polystyrene microspheres self-assembled into an ordered structure to form a photonic crystal layer having a blue-green luster and a thickness of about 5 micrometers to 20 micrometers, thereby a three-layer composite film having assembly substrate (PET film)/release layer/photonic crystal layer was obtained, the luster of which was measured by an X-RiteMA-98 spectrophotometer with a light source selected as D65/10°. The results are shown in Table 1.

TABLE 1

| Test angle | L* | a* | b* |
|---|---|---|---|
| 45as-15 | 138.84 | 27.02 | −39.71 |
| 45as15 | 53.26 | 53.02 | −14.78 |
| 45as25 | 51.56 | 52.04 | −9.38 |
| 45as45 | 50.35 | 51.62 | −1.87 |
| 45as75 | 53.94 | 48.92 | 0.23 |
| 45as110 | 51.03 | 43.41 | −1.08 |

### Example 2

Step 110: a biaxially oriented polypropylene (BOPP) film was used as an assembly substrate, but not limited thereto.

Step 120: a resin release agent was directly coated on a surface of the assembly substrate. After the resin release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 28 dyn/cm to 58 dyn/cm, but not limited thereto.

Step 130: preparing a silica microsphere suspension emulsion.

Firstly, 0.20 g of fuchsin basic was dissolved in 20 mL of DI water and sonicated for 20 minutes to obtain a magenta dye solution. Subsequently, a monodisperse silica microsphere suspension emulsion having a solid content of 10%, silica microspheres with a particle diameter of 195 nm, and a polydispersity index (PDI) of 0.02 was further provided. The magenta dye solution, the monodisperse silica microsphere suspension emulsion and absolute alcohol were blended in a volume ratio of 1:3:2, and dispersed by ultrasonication for 10 minutes to obtain a uniformly mixed magenta silica microsphere suspension emulsion.

It should be noted that the above example of preparing the photonic crystal emulsion is only for illustrating the present invention and do not limit the scope of the present invention, and the implementation conditions employed may be further adjusted according to specific operating conditions, and the unspecified implementation conditions are usually those in the conventional experiment.

Step 140: coating the photonic crystal emulsion on a surface of the release layer.

The photonic crystal emulsion was coated on the surface of the release layer by a roll-to-roll coating process. When the photonic crystal emulsion completely and uniformly covered the release layer, it was dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a three-layer composite film having assembly substrate (BOPP film)/release layer/photonic crystal layer was obtained, the luster of which was measured by an Elise MA-98 spectrophotometer with a light source selected as D65/10°. The results are shown in Table 2.

TABLE 2

| Test angle | L* | a* | b* |
|---|---|---|---|
| 45as-15 | 153.81 | 27.22 | −39.80 |
| 45as15 | 73.26 | 53.54 | −14.78 |
| 45as25 | 71.56 | 52.64 | −9.68 |
| 45as45 | 70.35 | 51.62 | −2.04 |
| 45as75 | 74.67 | 49.17 | 0.43 |
| 45as110 | 71.03 | 42.41 | −1.78 |

The advantage of the roll-to-roll coating process is that: the wettability of the photonic crystal emulsion on the surface of the release layer may be precisely regulated, that is, the interfacial properties of the surface may be regulated by the composition of the release layer, which may improve the coating suitability of the photonic crystal emulsion while reducing the addition of additives, moreover, large-area and defect-free coating of the photonic crystal emulsion may be performed on the surface of the release layer to realize a high-speed and high-quality photonic crystal coating.

The flexible and rewritable assembly substrate is selected to facilitate the roll-to-roll continuous assembly operation. The interfacial properties of the coated assembly substrate, such as the dyne value of the surface, are regulated by the release layer. A continuous and uniform layer of photonic crystal emulsion is coated on the surface of the assembly substrate by a roll-to-roll coating process. The temperature and time for drying are controlled so that the continuous phase in the photonic crystal emulsion is removed at an optimized rate. During the solvent removal process, the photonic crystal emulsion microspheres self-assemble into an opal-structure photonic crystal induced by weak interaction forces such as capillary force, thereby obtaining a large-area and defect-free photonic crystal layer on the assembly substrate.

### Embodiment 2

A manufacturing method of a transfer film having a photonic crystal structure disclosed in another embodiment of the present invention includes the following steps:

Step 210: providing an assembly substrate; Step 220: forming a release layer on a surface of the assembly substrate, the release layer for adjusting the interfacial properties of the assembly substrate;

Step 230: preparing a photonic crystal emulsion according to a surface tension coefficient of the release layer;

Step 240: coating the photonic crystal emulsion on a surface of the release layer, and curing the photonic crystal emulsion on the surface of the release layer into a photonic crystal layer;

Step 250: coating/printing a transfer layer on a surface of the photonic crystal layer; and

Step 260: providing a printing substrate, bonding the printing substrate to the transfer layer, and optionally removing the assembly substrate and the release layer from the photonic crystal layer.

### Example 3

Step 210: The assembly substrate may be a flexible and rollable substrate for use in a roll-to-roll coating process. The assembly substrate may be, but is not limited to, a polyethylene terephthalate film, a biaxially oriented polypropylene film, a polyethylene film, a cellulose film, a polyvinyl alcohol film, or paper. In this example, the assembly substrate was polyethylene terephthalate (PET) film, but not limited thereto.

Step 220: A silicone release agent was directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 28 dyn/cm to 35 dyn/cm, but not limited thereto.

Step 230: The specific implementation method was the same as step 130 of the foregoing Example 1, and details will not be repeated herein.

Step 240: The specific implementation method was substantially the same as the step 140 of the foregoing Example 1, and only the differences will be described below, and the rest will not be repeated herein. A photonic crystal emulsion was coated on a surface of the release layer by a roll-to-roll coating process. When the photonic crystal emulsion completely and uniformly covered the release layer, it was dried at 75° C. The polystyrene microspheres self-assembled into an ordered structure to form a photonic crystal layer having a blue-green luster and a thickness of about 5 micrometers to 20 micrometers, thereby a three-layer composite film having assembly substrate (PET film)/release layer/photonic crystal layer was obtained.

Step 250: coating a transfer layer on a surface of the photonic crystal layer. A transfer layer was coated on the photonic crystal layer. Firstly, a hot melt adhesive solvent (such as polyurethane) was uniformly coated on the surface of the photonic crystal layer, and then dried at 85° C. to form a transfer layer with the hot melt adhesive on the surface of the photonic crystal layer, thereby a thermal transfer film with assembly substrate (PET film)/release layer/photonic crystal layer/transfer layer was obtained.

Step 260: attaching a printing substrate to the adhesive surface of the transfer layer.

The printing substrate was bound to the transfer layer, and then stamped on the assembly substrate by a thermoprint mold which had a three-dimensional structural surface. The three-dimensional structural surface of the thermoprint mold was stamped on the assembly substrate at a temperature of 100° C. and a pressure of 3 kg in about 1 second, so that the transfer layer matched the three-dimensional structural surface to form an apparently three-dimensional pattern surface. In other words, the apparently three-dimensional pattern surface was based on the three-dimensional pattern or texture of the three-dimensional structural surface, so that the same three-dimensional appearance was reproduced.

Since the hot melt adhesive of the transfer layer was adhesive after being subjected to hot stamping, the photonic crystal layer was tightly bonded to the printing substrate through the transfer layer. Finally, the assembly substrate and the release layer were removed from the surface of the photonic crystal layer, and then a transfer film having the transfer layer (having the apparently three-dimensional pattern surface) and the photonic crystal layer was obtained on the printing substrate.

### Example 4

Step 210: The assembly substrate may be a flexible and rollable substrate for use in a roll-to-roll coating process. The assembly substrate may be, but is not limited to, a polyethylene terephthalate film, a biaxially oriented polypropylene film, a polyethylene film, a cellulose film, a polyvinyl alcohol film, or paper. In this example, the assembly substrate was biaxially oriented polypropylene (BOPP) film, but not limited thereto.

Step 220: A silicone release agent is directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer is controlled from 28 dyn/cm to 58 dyn/cm, but not limited thereto.

Step 230: The specific implementation method was the same as step 130 of the foregoing Example 1, and details will not be repeated herein.

Step 240: The specific implementation method was substantially the same as the step 140 of the foregoing Example 1, and only the differences will be described below, and the rest will not be repeated herein. A photonic crystal emulsion was coated on a surface of the release layer by a roll-to-roll coating process. When the photonic crystal emulsion completely and uniformly covered the release layer, it is dried at 75° C. The temperature and solvent volatilization were controlled to promote self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a three-layer composite film with assembly substrate (BOPP film)/release layer/photonic crystal layer was obtained.

Step 250: coating a transfer layer on a surface of the photonic crystal layer. A transfer layer was coated on the surface of the photonic crystal layer. Firstly, a resin precursor was coated on the surface of the photonic crystal layer. The coating method includes, but is not limited to, spin coating, slit coating, or blade coating. Wherein, the material of the resin precursor was ultraviolet curable resin. In this example, D8350 UV cold stamping adhesive was used, but not limited thereto.

The resin precursor was irradiated with ultraviolet light to form a resin film. Specifically, when the resin precursor was irradiated with ultraviolet light, the resin precursor would undergo a chemical curing reaction to form the resin film. By controlling the intensity, the irradiation time, and the wavelength of the ultraviolet light, the curing degree of the resin film may be controlled. Further, by the ultraviolet light irradiation, the structural strength of the resin film may be enhanced, and the resin film may be maintained in a fluid state to have plasticity. In this example, the curing degree of the resin film was 50%, but not limited thereto.

Step 260: attaching a printing substrate to the adhesive surface of the transfer layer.

The printing substrate and the semi-cured resin film were attached to each other, and then stamped on the printing substrate by an imprint mold which had a three-dimensional structural surface. The resin film was stamped with a three-dimensional pattern surface by the three-dimensional structure surface, and the three-dimensional pattern surface matched the pattern design of the imprint mold. However, the method for forming a three-dimensional pattern surface on the resin film is not limited to imprint, and in other examples, the three-dimensional pattern surface may be formed on the resin film by, for example, etching.

Thereafter, the resin film was completely cured, so that the resin film cured on the surface of the printing substrate to form a transfer layer, thereby an apparently three-dimensional pattern surface was formed on the surface of the transfer layer. Since the transfer layer was adhesive after cross-linking via ultraviolet light, the photonic crystal layer was tightly bonded to the printing substrate through the transfer layer. Finally, the assembly substrate and the release layer were removed from the surface of the photonic crystal layer, and a transfer film having the transfer layer (having the apparently three-dimensional pattern surface) and the photonic crystal layer was obtained on the printing substrate.

### Example 5

Step 210: The assembly substrate may be a flexible and rollable substrate for use in a roll-to-roll coating process. The assembly substrate may be, but is not limited to, a polyethylene terephthalate film, a biaxially oriented polypropylene film, a polyethylene film, a cellulose film, a polyvinyl alcohol film, or paper. In this example, the assembly substrate was biaxially oriented polypropylene (BOPP) film, but not limited thereto.

Step 220: A silicone release agent was directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 28 dyn/cm to 58 dyn/cm, but not limited thereto.

Step 230: The specific implementation method was the same as step 130 of the foregoing Example 1, and details will not be repeated herein.

Step 240: The specific implementation method was substantially the same as the step 140 of the foregoing Example 1, and only the differences will be described below, and the rest will not be repeated herein. A photonic crystal emulsion was coated on a surface of the release layer by a roll-to-roll coating process. When the photonic crystal emulsion completely and uniformly covered the release layer, it is dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a three-layer composite film with assembly substrate (BOPP film)/release layer/photonic crystal layer was obtained.

Step 250: coating a transfer layer on a surface of the photonic crystal layer.

A transfer layer was formed on the surface of the photonic crystal layer. Firstly, a resin precursor was printed on the surface of the photonic crystal layer to form a three-dimensional pattern surface based on a pattern of a printing plate. The printing method includes, but is not limited to, flexo printing and offset printing. Wherein, the material of the resin precursor was ultraviolet curable resin. In this example, D8350 UV cold stamping adhesive was used, but not limited thereto.

The resin precursor was irradiated with ultraviolet light to form a resin film. Specifically, when the resin precursor was irradiated with ultraviolet light, the resin precursor would undergo a chemical curing reaction to form the resin film. By controlling the intensity, the irradiation time, and the wavelength of the ultraviolet light, the curing degree of the resin film may be controlled. Further, by the ultraviolet light irradiation, the structural strength of the resin film may be enhanced, and the resin film may be maintained in a fluid state to have plasticity. In this example, the curing degree of the resin film was 50%, but not limited thereto.

Step 260: attaching a printing substrate to the adhesive surface of the transfer layer.

The printing substrate and the semi-cured resin film were bonded to each other, and then the resin film was completely cured, so that the resin film cured on a surface of the printing substrate to form a transfer layer, thereby an apparently three-dimensional pattern surface was formed on a surface of the transfer layer. Since the transfer layer was adhesive after cross-linking via ultraviolet light, the photonic crystal layer was tightly bonded to the printing substrate through the transfer layer. Finally, the assembly substrate and the release layer were removed from the surface of the photonic crystal layer, and a transfer film having the transfer layer (having the apparently three-dimensional pattern surface) and the photonic crystal layer was obtained on the printing substrate.

### Embodiment 3

A manufacturing method of a transfer film having a photonic crystal structure disclosed in yet another embodiment of the present invention includes the following steps:

Step 310: providing an assembly substrate; Step 320: forming a release layer on a surface of the assembly substrate, the release layer for adjusting the interfacial properties of the assembly substrate;

Step 330: preparing a photonic crystal emulsion according to a surface tension coefficient of the release layer;

Step 340: coating the photonic crystal emulsion on a surface of the release layer, and curing the photonic crystal emulsion on the surface of the release layer into a photonic crystal layer;

Step 350: providing a printing substrate, and coating a transfer layer on a surface of the printing substrate; and

Step 360: bonding the transfer layer on the printing substrate to a surface of the photonic crystal layer, and optionally removing the assembly substrate and the release layer from the photonic crystal layer.

### Example 6

Step 310: The assembly substrate may be a flexible and rollable substrate for use in a roll-to-roll coating process. The assembly substrate may be, but is not limited to, a polyethylene terephthalate film, a biaxially oriented polypropylene film, a polyethylene film, a cellulose film, a polyvinyl alcohol film, or paper. In this example, the assembly substrate was polyethylene terephthalate (PET) film, but not limited thereto.

Step 320: A silicone release agent was directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 28 dyn/cm to 35 dyn/cm, but not limited thereto.

Step 330: The specific implementation method was the same as step 130 of the foregoing Example 1, and details will not be repeated herein.

Step 340: The specific implementation method was substantially the same as the step 140 of the foregoing Example 1, and only the differences will be described below, and the rest will not be repeated herein. A photonic crystal emulsion was coated on a surface of the release layer by a roll-to-roll coating process. When the photonic crystal emulsion completely and uniformly covered the release layer, it is dried at 75° C. The polystyrene microspheres self-assembled into an ordered structure to form a photonic crystal layer having a blue-green luster and a thickness of about 5 micrometers to 20 micrometers, thereby a three-layer composite film having assembly substrate (PET film)/release layer/photonic crystal layer was obtained.

Step 350: coating a transfer layer on a surface of the printing substrate. Firstly, a hot melt adhesive (in this example, 909w transfer glue from was used, but not limited thereto) was uniformly coated on the surface of the printing substrate, and then dried at 85° C. to form a transfer layer with the hot melt adhesive on the surface of the photonic crystal layer, thereby a thermal transfer film with printing substrate/transfer layer.

Step 360: bonding the transfer layer on the printing substrate to a surface of the photonic crystal layer.

The transfer layer on the surface of the printing substrate was attached to the surface of the photonic crystal layer, and then stamped on the printing substrate by a thermoprint mold which had a three-dimensional structural surface. The three-dimensional structural surface of the thermoprint mold was stamped on the printing substrate at a temperature of 100° C. and a pressure of 3 kg in about 1 second, so that the transfer layer matched the three-dimensional structural surface to form an apparently three-dimensional pattern surface. In other words, the apparently three-dimensional pattern surface was based on the three-dimensional pattern or texture of the three-dimensional structural surface, so that the same three-dimensional appearance was reproduced.

Since the hot melt adhesive of the transfer layer was adhesive after being subjected to hot stamping, the photonic crystal layer was tightly bonded to the printing substrate through the transfer layer. Finally, the assembly substrate and the release layer were removed from the surface of the photonic crystal layer, and then a transfer film having the transfer layer (having the apparently three-dimensional pattern surface) and the photonic crystal layer was obtained on the printing substrate.

### Example 7

Step 310: The assembly substrate may be a flexible and rollable substrate for use in a roll-to-roll coating process. The assembly substrate may be, but is not limited to, a polyethylene terephthalate film, a biaxially oriented polypropylene film, a polyethylene film, a cellulose film, a polyvinyl alcohol film, or paper. In this example, the assembly substrate was biaxially oriented polypropylene (BOPP) film, but not limited thereto.

Step 320: A silicone release agent was directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 28 dyn/cm to 58 dyn/cm, but not limited thereto.

Step 330: The specific implementation method was the same as step 130 of the foregoing Example 2, and details will not be repeated herein.

Step 340: The specific implementation method was substantially the same as the step 140 of the foregoing Example 2, and only the differences will be described below, and the rest will not be repeated herein. A photonic crystal emulsion is coated on a surface of the release layer by a roll-to-roll coating process. When the photonic crystal emulsion completely and uniformly covered the release layer, it is dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a three-layer composite film with assembly substrate (BOPP film)/release layer/photonic crystal layer was obtained.

Step 350: coating a transfer layer on a surface of a printing substrate. A transfer layer was formed on the surface of the printing substrate. A resin precursor is firstly coated on the surface of the printing substrate. The coating method includes, but is not limited to, spin coating, slit coating, or blade coating. Wherein, the material of the resin precursor was ultraviolet curable resin. In this example, D8350 UV cold stamping adhesive was used, but not limited thereto.

The resin precursor was irradiated with ultraviolet light to form a resin film. Specifically, when the resin precursor was irradiated with ultraviolet light, the resin precursor would undergo a chemical curing reaction to form the resin film. By controlling the intensity, the irradiation time, and the wavelength of the ultraviolet light, the curing degree of the resin film may be controlled. Further, by the ultraviolet light irradiation, the structural strength of the resin film may be enhanced, and the resin film may be maintained in a fluid state to have plasticity. In this example, the curing degree of the resin film was 50%, but not limited thereto.

Step 360: bonding the transfer layer on the printing substrate to a surface of the photonic crystal layer.

The semi-cured resin film on the printing substrate was attached to the surface of the photonic crystal layer, and then stamped on the printing substrate by an imprint mold which had a three-dimensional structural surface. The resin film was stamped with a three-dimensional pattern surface by the three-dimensional structure surface, and the three-dimensional pattern surface matched the pattern design of the imprint mold. However, the method for forming a three-dimensional pattern surface on the resin film is not limited to imprint, and in other examples, the three-dimensional pattern surface may be formed on the resin film by, for example, etching.

Thereafter, the resin film was completely cured, so that the resin film cured between the printing substrate and the photonic crystal layer to form a transfer layer, thereby an apparently three-dimensional pattern surface was formed on a surface of the transfer layer. Since the transfer layer was adhesive after cross-linking via ultraviolet light, the photonic crystal layer was tightly bonded to the printing substrate through the transfer layer. Finally, the assembly substrate and the release layer were removed from the surface of the photonic crystal layer, and a transfer film having the transfer layer (having the apparently three-dimensional pattern surface) and the photonic crystal layer was obtained on the printing substrate.

The interface properties of the surface of the assembly substrate may be regulated by the composition of the release layer to improve the coating suitability of the photonic crystal emulsion. After drying, the photonic crystal emulsion may be closely attached to the release layer, so that the binding force between the release layer and the photonic crystal layer is greater than that between the assembly substrate and the release layer. The adhesive property of the transfer layer further makes the binding force between the printing substrate and the photonic crystal layer greater than that between the assembly substrate and the release layer. Therefore, the advantage of forming a photonic crystal layer as a consumable on the surface of the pre-assembly substrate is that the photonic crystal layer may be transferred to a surface of the printing substrate that is difficult to be directly assembled by means of transfer. The printing substrate may be, but is not limited to, a porous substrate, a curved substrate or a low-surface energy material substrate, for example, the printing substrate may be made of materials such as paper, plastic, glass, ceramic, leather, wood or metal, but not limited thereto. Moreover, the transfer layer with adhesion characteristics is supplemented to obtain a high adhesion on the printing substrate, and stamping with a thermoprint mold or a shapeable ultraviolet resin may be further used to achieve a patterning effect of the photonic crystal layer.

### Embodiment 4

A manufacturing method of a transfer film having a photonic crystal structure disclosed in yet another embodiment of the present invention includes the following steps:

Step 410: providing an assembly substrate; Step 420: forming a release layer on a surface of the assembly substrate, the release layer for adjusting the interfacial properties of the assembly substrate;

Step 430: preparing a photonic crystal emulsion according to a surface tension coefficient of the release layer;

Step 440: coating the photonic crystal emulsion on a surface of the release layer, and curing the photonic crystal emulsion on the surface of the release layer into a photonic crystal layer;

Step 450: providing a printing substrate, and coating or printing a transfer layer on a surface of the printing substrate or a surface of a photonic crystal layer; and

Step 460: bonding the transfer layer on the printing substrate to the surface of the photonic crystal layer, and optionally removing the assembly substrate from the release layer.

### Example 8

Step 410: The assembly substrate may be a flexible and rollable substrate for use in a roll-to-roll coating process. The assembly substrate may be, but is not limited to, a polyethylene terephthalate film, a biaxially oriented polypropylene film, a polyethylene film, a cellulose film, a polyvinyl alcohol film, or paper. In this example, the assembly substrate was polyethylene terephthalate (PET) film, but not limited thereto.

Step 420: A silicone release agent is directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 34 dyn/cm to 58 dyn/cm, but not limited thereto.

Step 430: The specific implementation method was the same as step 130 of the foregoing Example 1, and details will not be repeated herein.

Step 440: The specific implementation method was substantially the same as the step 140 of the foregoing Example 1, and only the differences will be described below, and the rest will not be repeated herein. A polystyrene nanosphere emulsion was coated on a surface of the release layer by a roll-to-roll coating process. When the polystyrene nanosphere emulsion completely and uniformly covered the release layer, it is dried at 75° C. The polystyrene nanospheres self-assembled into an ordered structure to form a photonic crystal layer having a blue-green luster and a thickness of about 5 micrometers to 20 micrometers, thereby a three-layer composite film having assembly substrate (PET film)/release layer/photonic crystal layer was obtained.

Step 450: coating a transfer layer on a surface of the photonic crystal layer. Firstly, a hot melt adhesive (in this example, 909w transfer glue was used) was uniformly coated on the surface of the photonic crystal layer, and then dried at 85° C. to form a transfer layer with the hot melt adhesive on the surface of the photonic crystal layer, thereby a thermal transfer film with assembly substrate (PET film)/release layer/photonic crystal layer/transfer layer was obtained.

Step 460: bonding the transfer layer on the surface of the photonic crystal layer to a surface of a printing substrate.

The transfer layer on the surface of the photonic crystal layer was attached to the surface of the printing substrate, and stamped on the assembly substrate by a thermoprint mold which had a three-dimensional structural surface. The three-dimensional structural surface of the thermoprint mold was stamped on the assembly substrate at a temperature of 100° C. and a pressure of 3 kg in about 1 second, so that the transfer layer matched the three-dimensional structural surface to form an apparently three-dimensional pattern surface. In other words, the apparently three-dimensional pattern surface was based on the three-dimensional pattern or the texture of the three-dimensional structural surface, so that the same three-dimensional appearance was reproduced.

Since the hot melt adhesive of the transfer layer was adhesive after being subjected to hot stamping, the photonic crystal layer was tightly bonded to the printing substrate through the transfer layer. Finally, the assembly substrate was removed from the surface of the release layer, and then a transfer film having the transfer layer (having the apparently three-dimensional pattern surface) and the photonic crystal layer was obtained on the printing substrate. At this time, the resin release agent was retained on the outside of the photonic crystal layer, protecting the surface of the photonic crystal layer from light.

### Example 9

Step 410: The assembly substrate may be a flexible and rollable substrate for use in a roll-to-roll coating process. The assembly substrate may be, but is not limited to, a polyethylene terephthalate film, a biaxially oriented polypropylene film, a polyethylene film, a cellulose film, a polyvinyl alcohol film, or paper. In this example, the assembly substrate was PET film, but not limited thereto.

Step 420: A resin release agent was directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 34 dyn/cm to 58 dyn/cm, but not limited thereto.

Step 430: The specific implementation method was the same as step 130 of the foregoing Example 2, and details will not be repeated herein.

Step 440: The specific implementation method was substantially the same as the step 140 of the foregoing Example 2, and only the differences will be described below, and the rest will not be repeated herein. A silica nanosphere emulsion was coated on a surface of the release layer by a roll-to-roll coating process. When the silica nanosphere emulsion completely and uniformly covered the release layer, it is dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a three-layer composite film with assembly substrate (PET film)/release layer/photonic crystal layer was obtained.

Step 450: coating a transfer layer on a surface of the photonic crystal layer. A transfer layer is formed on a surface of the photonic crystal layer. A resin precursor is firstly coated on the surface of photonic crystal layer. The coating method includes, but is not limited to, spin coating, slit coating, or blade coating. Wherein, the material of the resin precursor was ultraviolet curable resin. In this example, D8350 UV cold stamping adhesive was used, but not limited thereto.

The resin precursor was irradiated with ultraviolet light to form a resin film. Specifically, when the resin precursor was irradiated with ultraviolet light, the resin precursor would undergo a chemical curing reaction to form the resin film. By controlling the intensity, the irradiation time, and the wavelength of the ultraviolet light, the curing degree of the resin film may be controlled. Further, by the ultraviolet light irradiation, the structural strength of the resin film may be enhanced, and the resin film may be maintained in a fluid state to have plasticity. In this example, the curing degree of the resin film was 50%, but not limited thereto.

Step 460: bonding the transfer layer on the photonic crystal layer to a surface of a printing substrate.

The semi-cured resin film on the photonic crystal layer was attached to the surface of the printing substrate, and then stamped on the printing substrate by an imprint mold which had a three-dimensional structural surface. The resin film was stamped with a three-dimensional pattern surface by the three-dimensional structure surface, and the three-dimensional pattern surface matched the pattern design of the imprint mold. However, the method for forming a three-dimensional pattern surface on the resin film is not limited to imprint, and in other examples, the three-dimensional pattern surface may be formed on the resin film by, for example, etching.

Thereafter, the resin film was completely cured, so that the resin film cured between the printing substrate and the photonic crystal layer to form a transfer layer, thereby an apparently three-dimensional pattern surface was formed on a surface of the transfer layer. Since the transfer layer was adhesive after cross-linking via ultraviolet light, the photonic crystal layer was tightly bonded to the printing substrate through the transfer layer. Finally, the assembly substrate was removed from the surface of the release layer, and a transfer film having the transfer layer (having the apparently three-dimensional pattern surface) and the photonic crystal layer was obtained on the printing substrate.

### Example 10

Step 410: The assembly substrate may be a flexible and rollable substrate for use in a roll-to-roll coating process. The assembly substrate may be, but is not limited to, a polyethylene terephthalate film, a biaxially oriented polypropylene film, a polyethylene film, a cellulose film, a polyvinyl alcohol film, or paper. In this example, the assembly substrate was PET film, but not limited thereto.

Step 420: A resin release agent was directly coated on a surface of the assembly substrate. After the release agent was attached to the surface of the assembly substrate, it was dried, then the release agent cured on the surface of the assembly substrate, thereby a release layer was formed on the surface of the assembly substrate. In this example, the release agent material is merely illustrative and not limited thereto, and the interfacial properties of the surface of the assembly substrate may be regulated by the composition of the release layer. For example, the surface tension coefficient of the release layer was controlled from 34 dyn/cm to 58 dyn/cm, but not limited thereto.

Step 430: The specific implementation method was the same as step 130 of the foregoing Example 2, and details will not be repeated herein.

Step 440: The specific implementation method was substantially the same as the step 140 of the foregoing Example 2, and only the differences will be described below, and the rest will not be repeated herein. A silica nanosphere emulsion was coated on a surface of the release layer by a roll-to-roll coating process. When the silica nanosphere emulsion completely and uniformly covered the release layer, it is dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a three-layer composite film with assembly substrate (PET film)/release layer/photonic crystal layer was obtained.

Step 450: printing a transfer layer on a surface of a printing substrate. A transfer layer was formed on the surface of the printing substrate. A resin precursor was firstly printed on the surface of the printing substrate. The printing method includes, but is not limited to, offset printing and flexo printing. Wherein, the material of the resin precursor was ultraviolet curable resin. In this example, D8350 UV cold stamping adhesive was used, but not limited thereto.

The resin precursor was irradiated with ultraviolet light to form a resin film. Specifically, when the resin precursor was irradiated with ultraviolet light, the resin precursor would undergo a chemical curing reaction to form the resin film. By controlling the intensity, the irradiation time, and the wavelength of the ultraviolet light, the curing degree of the resin film may be controlled. Further, by the ultraviolet light irradiation, the structural strength of the resin film may be enhanced, and the resin film may be maintained in a fluid state to have plasticity. In this example, the curing degree of the resin film was 50%, but not limited thereto.

Step 460: bonding the transfer layer on the photonic crystal layer to a surface of the printing substrate.

The semi-cured resin film on the printing substrate was attached to the surface of the photonic crystal layer, and then the resin film was completely cured, so that the resin film cured between the printing substrate and the photonic crystal layer to form a transfer layer, thereby an apparently three-dimensional pattern surface was formed on a surface of the transfer layer. Since the transfer layer was adhesive after cross-linking via ultraviolet light, the photonic crystal layer was tightly bonded to the printing substrate through the transfer layer. Finally, the assembly substrate was removed from the surface of the release layer, and a transfer film having the transfer layer (having the apparently three-dimensional pattern surface) and the photonic crystal layer was obtained on the printing substrate.

The interface properties of the surface of the assembly substrate may be regulated by the composition of the release layer to improve the coating suitability of the photonic crystal emulsion. After drying, the photonic crystal emulsion may be closely attached to the release layer, so that the binding force between the release layer and the photonic crystal layer is greater than that between the assembly substrate and the release layer. The adhesion characteristics of the transfer layer further make the binding force between the printing substrate and the photonic crystal layer greater than that between the assembly substrate and the release layer. Therefore, the advantage of forming a photonic crystal layer as a consumable on a surface of the pre-assembly substrate is that the photonic crystal layer may be transferred to a surface of the printing substrate that is difficult to be directly assembled by means of transfer. The printing substrate may be, but is not limited to, a porous substrate, a curved substrate or a low-surface energy material substrate, for example, the printing substrate can be made of materials such as paper, plastic, glass, ceramic, leather, wood or metal, but not limited thereto. Moreover, the transfer layer with adhesion characteristics is supplemented to obtain a high adhesion on the printing substrate, and stamping with a thermoprint mold or a shapeable ultraviolet resin may be further used to achieve a patterning effect of the photonic crystal layer.

### Embodiment 5

A manufacturing method of a transfer film having a photonic crystal structure disclosed in yet another embodiment of the present invention includes the following steps:

Step 510: providing an assembly substrate;

Step 520: preparing a photonic crystal emulsion according to a surface tension coefficient of the assembly substrate; and

Step 530: coating the photonic crystal emulsion on a surface of the assembly substrate, and curing the photonic crystal emulsion on the surface of the assembly substrate into a photonic crystal layer.

### Example 11

Step 510: The assembly substrate may be a flexible and rollable substrate for use in a roll-to-roll coating process. The assembly substrate may be, but not limited to, a polyethylene terephthalate (PET) film, a biaxially oriented polypropylene (BOPP) film, a polyethylene (PE) film, a cellulose film, a polyvinyl alchohol (PVA) film or paper. In this example, the assembly substrate was polyethylene terephthalate (PET) film, but not limited thereto. The surface tension coefficient of the assembly substrate was from 28 dyn/cm to 58 dyn/cm (dyne per centimeter), but not limited thereto.

Step 520: preparing polystyrene nanospheres for synthesizing a polystyrene microsphere suspension emulsion.

Firstly, 0.58 g of sodium dodecyl sulfate (SDS) was dissolved in 90 mL of deionized water (DI water), and nitrogen gas was introduced while bubbling under uniformly stirring at 300 r/min for about 30 minutes. Subsequently, the temperature was raised to 85° C. by heating in a water bath. After the temperature was stable, 5 g of styrene (St) monomer was further added. After nitrogen gas was introduced while bubbling under uniformly stirring at 300 r/min for about 15 minutes, 0.10 g of potassium persulfate was added, and the mixture was reacted for 5 hours under stirring, under nitrogen atmosphere and at 85° C. to obtain a polystyrene microsphere suspension emulsion having a solid content of 5%, that is, a photonic crystal emulsion, in which the polystyrene microspheres had a particle diameter of 215 nm and a polydispersivity index (PDI) of 0.02.

It should be noted that the above example of preparing the photonic crystal emulsion is only for illustrating the present invention and do not limit the scope of the present invention, and the implementation conditions employed may be further adjusted according to specific operating conditions, and the unspecified implementation conditions are generally those in the conventional experiment.

Step 530: coating the photonic crystal emulsion on a surface of the assembly substrate.

The photonic crystal emulsion was coated on the surface of the assembly substrate by a roll-to-roll coating process. When the photonic crystal emulsion completely and uniformly covered the assembly substrate, it was dried at 75° C. The polystyrene microspheres self-assembled into an ordered structure to form a photonic crystal layer having a blue-green luster and a thickness of about 5 micrometers to 20 micrometers, thereby a two-layer composite film having assembly substrate (PET film)/photonic crystal layer was obtained.

### Example 12

Step 510: The assembly substrate may be a flexible and rollable substrate for use in a roll-to-roll coating process. The assembly substrate may be, but not limited to, a polyethylene terephthalate film, a biaxially oriented polypropylene film, a polyethylene film, a cellulose film, a polyvinyl alchohol (PVA) film or paper. In this example, the assembly substrate was biaxially oriented polypropylene (BOPP) film, but not limited thereto. The surface tension coefficient of the assembly substrate was from 28 dyn/cm to 58 dyn/cm (dyne per centimeter), but not limited thereto.

Step 520: preparing a silica microsphere suspension emulsion.

Firstly, 0.20 g of fuchsin basic was dissolved in 20 mL of DI water and sonicated for 20 minutes to obtain a magenta dye solution. Subsequently, a monodisperse silica microsphere suspension emulsion having a solid content of 10%, silica microspheres with a particle diameter of 195 nm, and a polydispersity index (PDI) of 0.02 was further provided. The magenta dye solution, the monodisperse silica microsphere suspension emulsion and absolute alcohol were blended in a volume ratio of 1:3:2, and dispersed by ultrasonication for 10 minutes to obtain a uniformly mixed magenta silica microsphere suspension emulsion.

It should be noted that the above example of preparing the photonic crystal emulsion is only for illustrating the present invention and do not limit the scope of the present invention, and the implementation conditions employed may be further adjusted according to specific operating conditions, and the unspecified implementation conditions are generally those in the conventional experiment.

Step 530: coating the photonic crystal emulsion on a surface of the assembly substrate.

The photonic crystal emulsion was coated on the surface of the assembly substrate by a roll-to-roll coating process. When the photonic crystal emulsion completely and uniformly covered the assembly substrate, it was dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a two-layer composite film with assembly substrate (BOPP film)/photonic crystal layer was obtained.

The advantage of the roll-to-roll coating process is that: the wettability of the photonic crystal emulsion on the surface of the assembly substrate may be precisely regulated according to the surface tension coefficient of the assembly substrate, which improves the coating suitability of the photonic crystal emulsion while reducing the addition of additives, moreover, large-area and defect-free coating of the photonic crystal emulsion may be performed on the surface of the release layer to realize a high-speed and high-quality photonic crystal coating.

The flexible and rewritable assembly substrate is selected to facilitate the roll-to-roll continuous assembly operation. The dyne value of the surface may be regulated by the assembly substrate. A continuous and uniform layer of photonic crystal emulsion is coated on the surface of the assembly substrate by roll-to-roll coating. The temperature and time for drying are controlled so that the continuous phase in the photonic crystal emulsion is removed at an optimized rate. During the solvent removal process, the photonic crystal emulsion microspheres self-assemble into an opal structure photonic crystal under the weak interaction force such as capillary force, thereby obtaining a large-area and defect-free photonic crystal layer on the assembly substrate.

### Embodiment 6

A manufacturing method of a transfer film having a photonic crystal structure disclosed in yet another example of the present invention includes the following steps:

Step 610: providing an assembly substrate;

Step 620: preparing a photonic crystal emulsion according to a surface tension coefficient of the assembly substrate;

Step 630: coating the photonic crystal emulsion on a surface of the assembly substrate, and curing the photonic crystal emulsion on the surface of the assembly substrate into a photonic crystal layer;

Step 640: coating a transfer layer on a surface of the photonic crystal layer; and

Step 650: providing a printing substrate, bonding the printing substrate to the transfer layer, and optionally removing the assembly substrate from the photonic crystal layer.

### Example 13

Step 610: The assembly substrate may be a flexible and rollable substrate for use in a roll-to-roll coating process. The assembly substrate may be, but not limited to, a polyethylene terephthalate film, a biaxially oriented polypropylene film, a polyethylene film, a cellulose film, a polyvinyl alchohol film or paper. In this example, the assembly substrate was polyethylene terephthalate (PET) film, but not limited thereto. The surface tension coefficient of the assembly substrate was from 28 dyn/cm to 58 dyn/cm (dyne per centimeter), but not limited thereto.

Step 620: The specific implementation method was the same as step 420 of the foregoing Example 8, and details will not be repeated herein.

Step 630: The specific implementation method was substantially the same as the step 430 of the foregoing Example 8, and only the differences will be described below, and the rest will not be repeated herein. A photonic crystal emulsion was coated on a surface of the assembly substrate by a roll-to-roll coating process. When the photonic crystal emulsion completely and uniformly covered the release layer, it was dried at 75° C. The polystyrene microspheres self-assembled into an ordered structure to form a photonic crystal layer having a blue-green luster and a thickness of about 5 micrometers to 20 micrometers, thereby a two-layer composite film having assembly substrate (PET film)/photonic crystal layer was obtained.

Step 640: coating a transfer layer on a surface of the photonic crystal layer. A transfer layer was coated on the photonic crystal layer. Firstly, a hot melt adhesive (in this example, 909w hot melt adhesive was used, but not limited thereto) was uniformly coated on a surface of the photonic crystal layer, and then dried at 85° C. to form a transfer layer with the hot melt adhesive on the surface of the photonic crystal layer, thereby a thermal transfer film with assembly substrate (PET film)/photonic crystal layer/transfer layer was formed.

Step 650: attaching a printing substrate to the adhesive surface of the transfer layer.

The printing substrate was bound to the transfer layer, and stamped on the assembly substrate which had a three-dimensional structural surface. The three-dimensional structural surface of the thermoprint mold was stamped on the assembly substrate at a temperature of 100° C. and a pressure of 3 kg in about 1 second, so that the transfer layer matched the three-dimensional structural surface to form an apparently three-dimensional pattern surface. In other words, the apparently three-dimensional pattern surface was based on the three-dimensional pattern or texture of the three-dimensional structural surface, so that the same three-dimensional appearance was reproduced.

Since the hot melt adhesive of the transfer layer was adhesive after being subjected to hot stamping, the photonic crystal layer was tightly bonded to the printing substrate through the transfer layer. Finally, the assembly substrate was removed from the surface of the photonic crystal layer, and a transfer film having the transfer layer (having the apparently three-dimensional pattern surface) and the photonic crystal layer was obtained on the printing substrate.

### Example 14

Step 610: The assembly substrate may be a flexible and rollable substrate for use in a roll-to-roll coating process. The assembly substrate may be, but not limited to, a polyethylene terephthalate film, a biaxially oriented polypropylene film, a polyethylene film, a cellulose film, a polyvinyl alchohol film or paper. In this example, the assembly substrate was biaxially oriented polypropylene (BOPP) film, but not limited thereto. The surface tension coefficient of the assembly substrate was from 28 dyn/cm to 58 dyn/cm (dyne per centimeter), but not limited thereto.

Step 620: The specific implementation method was the same as step 420 of the foregoing Example 8, and details will not be repeated herein.

Step 630: The specific implementation method was substantially the same as the step 430 of the foregoing Example 8, and only the differences will be described below, and the rest will not be repeated herein. A photonic crystal emulsion was coated on a surface of the assembly substrate by a roll-to-roll coating process. When the photonic crystal emulsion completely and uniformly covered the assembly substrate, it is dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a two-layer composite film with assembly substrate (BOPP film)/photonic crystal layer was obtained.

Step 640: coating a transfer layer on a surface of the photonic crystal layer.

A transfer layer was formed on the photonic crystal layer. A resin precursor was firstly coated on the surface of the photonic crystal layer. The coating method includes, but is not limited to, spin coating, slit coating, or blade coating. Wherein, the material of the resin precursor was ultraviolet curable resin. In this example, D8350 UV cold stamping adhesive was used, but not limited thereto.

The resin precursor was irradiated with ultraviolet light to form a resin film. Specifically, when the resin precursor was irradiated with ultraviolet light, the resin precursor would undergo a chemical curing reaction to form the resin film. By controlling the intensity, the irradiation time, and the wavelength of the ultraviolet light, the curing degree of the resin film may be controlled. Further, by the ultraviolet light irradiation, the structural strength of the resin film may be enhanced, and the resin film may be maintained in a fluid state to have plasticity. In this example, the curing degree of the resin film was 50%, but not limited thereto.

Step 650: attaching a printing substrate to the adhesive surface of the transfer layer.

The printing substrate and the semi-cured resin film were attached to each other, and then stamped on the printing substrate by an imprint mold which had a three-dimensional structural surface. The resin film was stamped with a three-dimensional pattern surface by the three-dimensional structure surface, and the three-dimensional pattern surface matched the pattern design of the imprint mold. However, the method for forming a three-dimensional pattern surface on the resin film is not limited to imprint, and in other examples, the three-dimensional pattern surface may be formed on the resin film by, for example, etching.

The resin film was then completely cured, so that the resin film cured on the surface of the printing substrate to form a transfer layer, thereby an apparently three-dimensional pattern surface was formed on a surface of the transfer layer. Since the transfer layer was adhesive after cross-linking via ultraviolet light, the photonic crystal layer was tightly bonded to the printing substrate through the transfer layer. Finally, the assembly substrate was removed from the surface of the photonic crystal layer, and a transfer film having the transfer layer (having the apparently three-dimensional pattern surface) and the photonic crystal layer was obtained on the printing substrate.

### Embodiment 7

The following is a manufacturing method of a transfer film having a photonic crystal structure disclosed in yet another embodiment of the present invention, including the following steps:

Step 710: providing an assembly substrate;

Step 720: preparing a photonic crystal emulsion according to a surface tension coefficient of the assembly substrate;

Step 730: coating the photonic crystal emulsion on a surface of the assembly substrate, and curing the photonic crystal emulsion on the surface of the assembly substrate into a photonic crystal layer;

Step 740: providing a printing substrate, and coating a transfer layer on a surface of the printing substrate; and

Step 750: bonding the transfer layer on the printing substrate to a surface of the photonic crystal layer, and optionally removing the assembly substrate from the photonic crystal layer.

### Example 15

Step 710: The assembly substrate may be a flexible and rollable substrate for use in a roll-to-roll coating process. The assembly substrate may be, but not limited to, a polyethylene terephthalate film, a biaxially oriented polypropylene film, a polyethylene film, a cellulose film, a polyvinyl alchohol film or paper. In this example, the assembly substrate was polyethylene terephthalate (PET) film, but not limited thereto. The surface tension coefficient of the assembly substrate was from 28 dyn/cm to 58 dyn/cm (dyne per centimeter), but not limited thereto.

Step 720: The specific implementation method was the same as step 420 of the foregoing Example 8, and details will not be repeated herein.

Step 730: The specific implementation method was substantially the same as the step 430 of the foregoing Example 8, and only the differences will be described below, and the rest will not be repeated herein. A photonic crystal emulsion was coated on a surface of the assembly substrate by a roll-to-roll coating process. When the photonic crystal emulsion completely and uniformly covered the assembly substrate, it was dried at 75° C. The polystyrene microspheres self-assembled into an ordered structure to form a photonic crystal layer having a blue-green luster and a thickness of about 5 micrometers to 20 micrometers, thereby a two-layer composite film having assembly substrate (PET film)/photonic crystal layer was obtained.

Step 740: coating a transfer layer on a surface of a printing substrate.

A transfer layer was coated on the printing substrate. Firstly, a hot melt adhesive solvent (such as polyurethane) was uniformly coated on the surface of the printing substrate, and then dried at 85° C. to form a transfer layer with the hot melt adhesive on the surface of the printing substrate, thereby a thermal transfer film with printing substrate/photonic crystal layer/transfer layer.

Step 750: bonding the transfer layer on the printing substrate to a surface of the photonic crystal layer.

The transfer layer on the surface of the printing substrate was attached to the surface of the photonic crystal layer, and stamped on the printing substrate or the assembly substrate by a thermoprint mold which had a three-dimensional structural surface. The three-dimensional structural surface of the thermoprint mold was stamped on the assembly substrate at a temperature of 100° C. and a pressure of 3 kg in about 1 second, so that the transfer layer matched the three-dimensional structural surface to form an apparently three-dimensional pattern surface. In other words, the apparently three-dimensional pattern surface was based on the three-dimensional pattern or texture of the three-dimensional structural surface, so that the same three-dimensional appearance was reproduced.

Since the hot melt adhesive of the transfer layer was adhesive after being subjected to hot stamping, the photonic crystal layer was tightly bonded to the printing substrate through the transfer layer. Finally, the assembly substrate was removed from the surface of the photonic crystal layer, and a transfer film having the transfer layer (having the apparently three-dimensional pattern surface) and the photonic crystal layer was obtained on the printing substrate.

### Example 16

Step 710: The assembly substrate may be a flexible and rollable substrate for use in a roll-to-roll coating process. The assembly substrate may be, but not limited to, a polyethylene terephthalate film, a biaxially oriented polypropylene film, a polyethylene film, a cellulose film, a polyvinyl alchohol film or paper. In this example, the assembly substrate was biaxially oriented polypropylene (BOPP) film, but not limited thereto. The surface tension coefficient of the assembly substrate was from 28 dyn/cm to 58 dyn/cm (dyne per centimeter), but not limited thereto.

Step 720: The specific implementation method was the same as step 420 of the foregoing Example 8, and details will not be repeated herein.

Step 730: The specific implementation method was substantially the same as the step 430 of the foregoing Example 8, and only the differences will be described below, and the rest will not be repeated herein. A photonic crystal emulsion was coated on a surface of the release layer by a roll-to-roll coating process. When the photonic crystal emulsion completely and uniformly covered the release layer, it is dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a two-layer composite film with assembly substrate (BOPP film)/photonic crystal layer was obtained.

Step 740: coating a transfer layer on a surface of a printing substrate.

A transfer layer was formed on the surface of the printing substrate. A resin precursor was firstly coated on the surface of the printing substrate. The coating method includes, but is not limited to, spin coating, slit coating, or blade coating. Wherein, the material of the resin precursor was ultraviolet curable resin. In this example, D8350 UV cold stamping adhesive was used, but not limited thereto.

The resin precursor was irradiated with ultraviolet light to form a resin film. Specifically, when the resin precursor was irradiated with ultraviolet light, the resin precursor would undergo a chemical curing reaction to form the resin film. By controlling the intensity, the irradiation time, and the wavelength of the ultraviolet light, the curing degree of the resin film may be controlled. Further, by the ultraviolet light irradiation, the structural strength of the resin film may be enhanced, and the resin film may be maintained in a fluid state to have plasticity. In this example, the curing degree of the resin film was 50%, but not limited thereto.

Step 760: bonding the transfer layer on the printing substrate to a surface of the photonic crystal layer.

The semi-cured resin film on the printing substrate was attached to the surface of the photonic crystal layer, and then stamped on the printing substrate by an imprint mold which had a three-dimensional structural surface. The resin film was stamped with a three-dimensional pattern surface by the three-dimensional structure surface, and the three-dimensional pattern surface matched the pattern design of the imprint mold. However, the method for forming a three-dimensional pattern surface on the resin film is not limited to imprint, and in other examples, the three-dimensional pattern surface may be formed on the resin film by, for example, etching.

Thereafter, the resin film was completely cured, so that the resin film cured between the printing substrate and the photonic crystal layer to form a transfer layer, thereby an apparently three-dimensional pattern surface was formed on a surface of the transfer layer. Since the transfer layer was adhesive after cross-linking via ultraviolet light, the photonic crystal layer was tightly bonded to the printing substrate through the transfer layer. Finally, the assembly substrate was removed from the surface of the photonic crystal layer, and a transfer film having the transfer layer (having the apparently three-dimensional pattern surface) and the photonic crystal layer was obtained on the printing substrate.

### Embodiment 8

The following is a manufacturing method of a transfer film having a photonic crystal structure disclosed in yet another embodiment of the present invention, including the following steps:

Step 810: providing an assembly substrate;

Step 820: preparing a photonic crystal emulsion according to a surface tension coefficient of the assembly substrate;

Step 830: coating the photonic crystal emulsion on a surface of the assembly substrate, and curing the photonic crystal emulsion on the surface of the assembly substrate into a photonic crystal layer;

Step 840: providing a printing substrate, and coating a transfer layer on a surface of the printing substrate; and

Step 850: bonding the transfer layer on the printing substrate to a surface of the photonic crystal layer.

### Example 17

Step 810: The assembly substrate may be a flexible and rollable substrate for use in a roll-to-roll coating process. The assembly substrate may be, but not limited to, a polyethylene terephthalate film, a biaxially oriented polypropylene film, a polyethylene film, a cellulose film, a polyvinyl alchohol film or paper. In this example, the assembly substrate was polyethylene terephthalate (PET) film, but not limited thereto. The surface tension coefficient of the assembly substrate was from 28 dyn/cm to 58 dyn/cm (dyne per centimeter), but not limited thereto.

Step 820: The specific implementation method was the same as step 420 of the foregoing Example 8, and details will not be repeated herein.

Step 830: The specific implementation method was substantially the same as the step 430 of the foregoing Example 8, and only the differences will be described below, and the rest will not be repeated herein. A photonic crystal emulsion was coated on a surface of the assembly substrate by a roll-to-roll coating process. When the photonic crystal emulsion completely and uniformly covered the assembly substrate, it was dried at 75° C. The polystyrene microspheres self-assembled into an ordered structure to form a photonic crystal layer having a blue-green luster and a thickness of about 5 micrometers to 20 micrometers, thereby a two-layer composite film having assembly substrate (PET film)/photonic crystal layer was obtained.

Step 840: coating a transfer layer on a surface of a printing substrate.

A transfer layer was coated on the printing substrate. Firstly, a hot melt adhesive (in this example, 809 hot melt adhesive was used, but not limited thereto) was uniformly coated on the surface of the printing substrate, and then dried at 85° C. to form a transfer layer with the hot melt adhesive on the surface of the printing substrate, thereby a thermal transfer film with printing substrate (PET film)/photonic crystal layer/transfer layer was formed.

Step 850: bonding the transfer layer on the printing substrate to a surface of the photonic crystal layer.

The transfer layer of the surface of the printing substrate was attached to a surface of the photonic crystal layer, and stamped on the printing substrate or the assembly substrate by a thermoprint mold which had a three-dimensional structural surface. The three-dimensional structural surface of the thermoprint mold was stamped on the assembly substrate at a temperature of 100° C. and a pressure of 3 kg in about 1 second, so that the transfer layer matched the three-dimensional structural surface to form an apparently three-dimensional pattern surface. In other words, the apparently three-dimensional pattern surface was based on the three-dimensional pattern or texture of the three-dimensional structural surface, so that the same three-dimensional appearance was reproduced.

Since the hot melt adhesive of the transfer layer was adhesive after being subjected to hot stamping, the photonic crystal layer was tightly bonded to the printing substrate through the transfer layer, and a transfer film having the transfer layer, the photonic crystal layer, and the assembly substrate was obtained on the printing substrate.

### Example 18

Step 810: The assembly substrate may be a flexible and rollable substrate for use in a roll-to-roll coating process. The assembly substrate may be, but not limited to, a polyethylene terephthalate film, a biaxially oriented polypropylene film, a polyethylene film, a cellulose film, a polyvinyl alchohol film or paper. In this example, the assembly substrate was biaxially oriented polypropylene (BOPP) film, but not limited thereto. The surface tension coefficient of the assembly substrate was from 28 dyn/cm to 58 dyn/cm (dyne per centimeter), but not limited thereto.

Step 820: The specific implementation method was the same as step 420 of the foregoing Example 8, and details will not be repeated herein.

Step 830: The specific implementation method was substantially the same as the step 430 of the foregoing Example 8, and only the differences will be described below, and the rest will not be repeated herein. A photonic crystal emulsion was coated on a surface of the release layer by a roll-to-roll coating process. When the photonic crystal emulsion completely and uniformly covered the release layer, it is dried at 75° C. The temperature and solvent volatilization were controlled to promote the self-assembly mechanism of the magenta silica microspheres in the magenta silica microsphere suspension emulsion (i.e., the photonic crystal emulsion) on gas-liquid surface, so that the magenta silica microspheres self-assembled into an ordered structure to form a photonic crystal layer having a blue-green luster and a thickness of about 5 micrometers to 20 micrometers, thereby a two-layer composite film with assembly substrate (BOPP film)/photonic crystal layer was obtained.

Step 840: coating a transfer layer on a surface of a printing substrate.

A transfer layer was formed on the surface of the printing substrate. A resin precursor was firstly coated on the surface of printing substrate. The coating method includes, but is not limited to, spin coating, slit coating, or blade coating. Wherein, the material of the resin precursor was ultraviolet curable resin. In this example, DIMAX D8350 UV cold stamping adhesive was used, but not limited thereto.

The resin precursor was irradiated with ultraviolet light to form a resin film. Specifically, when the resin precursor was irradiated with ultraviolet light, the resin precursor would undergo a chemical curing reaction to form the resin film. By controlling the intensity, the irradiation time, and the wavelength of the ultraviolet light, the curing degree of the resin film may be controlled. Further, by the ultraviolet light irradiation, the structural strength of the resin film may be enhanced, and the resin film may be maintained in a fluid state to have plasticity. In this example, the curing degree of the resin film was 50%, but not limited thereto.

Step 860: bonding the transfer layer on the printing substrate to a surface of the photonic crystal layer.

The semi-cured resin film on the printing substrate was attached to the surface of the photonic crystal layer, and then stamped on the printing substrate by an imprint mold which had a three-dimensional structural surface. The resin film was stamped with a three-dimensional pattern surface by the three-dimensional structure surface, and the three-dimensional pattern surface matched the pattern design of the imprint mold. However, the method for forming a three-dimensional pattern surface on the resin film is not limited to imprint, and in other examples, the three-dimensional pattern surface may be formed on the resin film by, for example, etching.

Thereafter, the resin film was completely cured, so that the resin film cured between the printing substrate and the photonic crystal layer to form a transfer layer, thereby an apparently three-dimensional pattern surface was formed. Since the transfer layer was adhesive after cross-linking via ultraviolet light, the photonic crystal layer was tightly bonded to the printing substrate through the transfer layer, and a transfer film having the transfer layer, the photonic crystal layer, and the assembly substrate was obtained on the printing substrate.

The wettability and coating suitability of the photonic crystal emulsion on the surface of the assembly substrate may be precisely regulated according to a surface tension coefficient of the assembly substrate. The photonic crystal emulsion may be closely attached to the assembly substrate after drying. The adhesive characteristics of the transfer layer further makes the binding force between the printing substrate and the photonic crystal layer greater than that between the assembly substrate and the photonic crystal layer, thereby realizing patterning of the photonic crystal layer on the printing substrate. Therefore, the advantage of forming a photonic crystal layer as a consumable on a surface of the pre-assembly substrate is that: by simple and convenient transfer method, the adhesion of high-quality photonic crystal layer may be realized on a substrate of a printing surface that is difficult to be directly assembled by conventional photonic crystals. The printing substrate can be, but is not limited to, a porous substrate, a curved substrate or a low surface energy material substrate, for example, the printing substrate can be made of materials such as paper, plastic, glass, ceramic, leather, wood or metal, but not limited thereto. Moreover, the transfer layer with adhesion characteristics is supplemented to obtain a high adhesion on the printing substrate, and stamping with a thermoprint mold or an ultraviolet resin which may be shaped by printing, etching or the like may further used to realize a patterning effect of the photonic crystal layer.

In summary, according to the transfer film having the photonic crystal structure and the manufacturing method thereof disclosed in all the embodiments of the present invention described above, the wettability and coating suitability of the photonic crystal emulsion on the surface of the assembly substrate may be precisely regulated according to the surface tension coefficient of the assembly substrate, or the coating suitability of the photonic crystal emulsion may be improved with as few additives as possible by using the release layer of the surface of assembly substrate as a prime coat layer of the photonic crystal emulsion, so that the photonic crystal emulsion may be uniformly coated on the surface of assembly substrate, further supplemented by a roll-to-roll coating process, so as to achieve a large-area and defect-free coating effect and increase coating speed, thereby reducing coating time and cost. Moreover, after the roll-to-roll coating, it may be directly dried, and the temperature, humidity, time and solvent evaporation degree of the drying are controlled, so that the continuous phase in the photonic crystal emulsion is removed at an optimized rate, which promotes the self-assembly behavior of the microspheres in the photonic crystal emulsion on the gas-liquid surface, so as to achieve a high-speed and high-quality assembly of the photonic crystal emulsion on the assembly substrate and obtain a large-area and defect-free photonic crystal layer.

After the photonic crystal emulsion forms a photonic crystal layer on the surface of the assembly substrate, a transfer layer may be further coated on a surface of the photonic crystal layer, or a transfer layer may be coated on a surface of the printing substrate, and an apparently three-dimensional pattern surface may be formed by hot stamping or ultraviolet cross-linking. Meanwhile, through the adhesive transfer layer, the photonic crystal layer has good adherence with the printing substrate, and the cured three-dimensional pattern surface has good wear resistance, scratch resistance and hardness, and is not affected by high temperature and high humidity environment. The assembly substrate is then removed from the photonic crystal layer to obtain a transfer film having a photonic crystal structure. Of course, the assembly substrate of the present invention also may not be removed.

1. A transfer film having a photonic crystal structure, comprising:
an assembly substrate,
a photonic crystal layer,
a transfer layer,
and a printing substrate.

2. The transfer film of claim 1, wherein the photonic crystal layer comprises a nanosphere layer formed by periodic arrangement of nanospheres, and the nanosphere layer has a close-packed structure.

3. The transfer film of claim 2, wherein the raw material of the nanosphere is selected from the group consisting of polystyrene, polyacrylate, polyacrylic acid, silica, alumina, titania, zirconia, polyimide, silicon resin, iron oxide and phenolic resin ester.

4. The transfer film of claim 2, wherein the luster of the photonic crystal layer is infrared light, visible light or ultraviolet light having a wavelength of 200 to 2000 nm.

5. The transfer film of claim 2, wherein the nanospheres are filled with a filling medium, and a dielectric constant of the filling medium is different from a dielectric constant of the nanospheres.

6. The transfer film of claim 2, wherein the nanosphere has a PDI of less than 0.05.

7. The transfer film of claim 3, wherein the assembly substrate is a polyethylene terephthalate (PET) film, a polypropylene (PP) film, a polyethylene (PE) film, a cellulose film, a polyvinyl alcohol (PVA) film, a PVC film or paper.

8. The transfer film of claim 7, wherein the printing substrate is a porous substrate, a curved substrate or a low-surface energy material substrate, the porous substrate includes fiber paper, cloth, leather, wood or a substrate material having a rough and porous surface and capable of absorbing a photonic crystal emulsion, and the curved substrate includes a curved paper, plastic, glass, ceramic, leather, wood, metal or substrate material and a photonic crystal emulsion cannot be spread, assembled and cured on a surface of the substrate material to form the photonic crystal layer.

9. The transfer film of claim 8, wherein the transfer layer is made of a hot melt adhesive or a UV resin precursor.

10. The transfer film of claim 8, further comprising a release layer between the assembly substrate and the photonic crystal layer.

11. The transfer film of claim 10, wherein the release layer has a surface tension coefficient of 28 dyn/cm to 58 dyn/cm, and the photonic crystal layer has a thickness of 2 μm to 20 μm.

12. A manufacturing method of the transfer film of claim 1, comprising the following steps:
providing an assembly substrate;
preparing a photonic crystal emulsion;
coating the prepared photonic crystal emulsion on a surface of the assembly substrate, curing the photonic crystal emulsion on the surface of the assembly substrate into a photonic crystal layer;
bonding the photonic crystal layer to a printing substrate by transfer and forming a transfer layer;
and then optionally removing the assembly substrate.

13. The manufacturing method of claim 12, wherein the step of coating the photonic crystal emulsion on the surface of the assembly substrate comprises:
coating the photonic crystal emulsion on the surface of the assembly substrate to obtain a continuous photonic crystal layer.

14. The manufacturing method of claim 12, wherein the step of bonding the photonic crystal layer to the printing substrate by transfer and forming the transfer layer comprises: coating a hot melt adhesive solvent on a surface of the photonic crystal layer or a surface of the printing substrate, followed by drying, and then stamping a three-dimensional structural surface of a thermoprint mold on the printing substrate or the assembly substrate to form an apparently three-dimensional pattern surface, thereby bonding the photonic crystal layer to the printing substrate and forming the transfer layer; or,
the step of bonding the photonic crystal layer to the printing substrate by transfer and forming the transfer layer comprises: coating a UV resin precursor on a surface of the photonic crystal layer or a surface of the printing substrate, followed by ultraviolet light irradiation, and then stamping a three-dimensional structural surface of an imprint mold on the printing substrate or the assembly substrate, and then completely curing the resin film to form an apparently three-dimensional pattern surface, thereby bonding the photonic crystal layer to the printing substrate and forming the transfer layer; or,
the step of bonding the photonic crystal layer to the printing substrate by transfer and forming the transfer layer comprises: printing a UV resin precursor on a surface of the photonic crystal layer or a surface of the printing substrate, followed by ultraviolet light irradiation to form a three-dimensional pattern surface, and then completely curing the resin film to form an apparently three-dimensional pattern surface, thereby bonding the photonic crystal layer to the printing substrate and forming the transfer layer.

15. The manufacturing method of claim 12, wherein the photonic crystal layer comprises a nanosphere layer formed by periodic arrangement of nanospheres, and the nanosphere layer has a close-packed structure;
the raw material of the nanosphere is selected from the group consisting of polystyrene, polyacrylate, polyacrylic acid, silica, alumina, titania, zirconia, polyimide, silicon resin, iron oxide and phenolic resin ester;
the nanospheres are filled with a filling medium, and a dielectric constant of the filling medium is different from a dielectric constant of the nanospheres; and
the nanosphere has a PDI of less than 0.05.

16. The manufacturing method of claim 12, wherein the assembly substrate is a polyethylene terephthalate (PET) film, a polypropylene (PP) film, a polyethylene (PE) film, a cellulose film, a polyvinyl alcohol (PVA) film, a PVC film or paper; and
the printing substrate is a porous substrate, a curved substrate or a low-surface energy material substrate, the porous substrate includes fiber paper, cloth, leather, wood or a substrate material having a rough and porous surface and capable of absorbing a photonic crystal emulsion, and the curved substrate includes a curved paper, plastic, glass, ceramic, leather, wood, metal or substrate material and a photonic crystal emulsion cannot be spread, assembled and cured on a surface of the substrate material to form the photonic crystal layer.

17. A manufacturing method of the transfer film of claim 10, comprising the following steps:
providing an assembly substrate;
forming a release layer on a surface of the assembly substrate, the release layer for regulating an interface property of the assembly substrate;
preparing a photonic crystal emulsion;
coating the prepared photonic crystal emulsion on a surface of the release layer, curing the photonic crystal emulsion on the surface of the release layer into a photonic crystal layer;
bonding the photonic crystal layer to a printing substrate by transfer and forming a transfer layer;
and then optionally removing the assembly substrate.

18. The manufacturing method of claim 17, wherein the step of coating the photonic crystal emulsion on the surface of the assembly substrate comprises:
coating the photonic crystal emulsion on the surface of the assembly substrate to obtain a continuous photonic crystal layer.

19. The manufacturing method of claim 17, wherein the step of bonding the photonic crystal layer to the printing substrate by transfer and forming the transfer layer comprises: coating a hot melt adhesive solvent on a surface of the photonic crystal layer or a surface of the printing substrate, followed by drying, and then stamping a three-dimensional structural surface of a thermoprint mold on the printing substrate or the assembly substrate to form an apparently three-dimensional pattern surface, thereby bonding the photonic crystal layer to the printing substrate and forming the transfer layer; or,
the step of bonding the photonic crystal layer to the printing substrate by transfer and forming the transfer layer comprises: coating a UV resin precursor on a surface of the photonic crystal layer or a surface of the printing substrate, followed by ultraviolet light irradiation, and then stamping a three-dimensional structural surface of an imprint mold on the printing substrate or the assembly substrate, and then completely curing the resin film to form an apparently three-dimensional pattern surface, thereby bonding the photonic crystal layer to the printing substrate and forming the transfer layer; or,
the step of bonding the photonic crystal layer to the printing substrate by transfer and forming the transfer layer comprises: printing a UV resin precursor on a surface of the photonic crystal layer or a surface of the printing substrate, followed by ultraviolet light irradiation to form a three-dimensional pattern surface, and then completely curing the resin film to form an apparently three-dimensional pattern surface, thereby bonding the photonic crystal layer to the printing substrate and forming the transfer layer; or,
the step of bonding the photonic crystal layer to the printing substrate by transfer and forming the transfer layer comprises: coating a hot melt adhesive solvent on a surface of the photonic crystal layer or a surface of the printing substrate, followed by drying, and then stamping a three-dimensional structural surface of a thermoprint mold on the printing substrate or the assembly substrate to form an apparently three-dimensional pattern surface, thereby bonding the photonic crystal layer to the printing substrate and forming the transfer layer; or,
the step of bonding the photonic crystal layer to the printing substrate by transfer and forming the transfer layer comprises: coating a UV resin precursor on a surface of the photonic crystal layer or a surface of the printing substrate, followed by ultraviolet light irradiation, and then stamping a three-dimensional structural surface of an imprint mold on the printing substrate or the assembly substrate, and then completely curing the resin film to form an apparently three-dimensional pattern surface, thereby bonding the photonic crystal layer to the printing substrate and forming the transfer layer; or,
the step of bonding the photonic crystal layer to the printing substrate by transfer and forming the transfer layer comprises: printing a UV resin precursor on a surface of the photonic crystal layer or a surface of the printing substrate, followed by ultraviolet light irradiation to form a three-dimensional pattern surface, and then completely curing the resin film to form an apparently three-dimensional pattern surface, thereby bonding the photonic crystal layer to the printing substrate and forming the transfer layer.

20. The manufacturing method of claim 17, wherein the release layer has a surface tension coefficient of 28 dyn/cm to 58 dyn/cm, and the photonic crystal layer has a thickness of 2 μm to 20 μm.
